(19) United States
(12) Patent Application Publication
(10) Pub. No.: US 2017/0208758 A1
(43) Pub. Date: Jul. 27, 2017

(54) ENVIRONMENTALLY-FRIENDLY AQUATIC PLANT GROWING STAND

(71) Applicant: Yong-In BAEK, Namyangju-si (KR)

(72) Inventor: Yong-In BAEK, Namyangju-si (KR)

(21) Appl. No.: 15/309,734

(22) PCT Filed: Sep. 3, 2014
(86) PCT No.: PCT/KR14/08239

§ 371 Date: Nov. 8, 2016

(30) Foreign Application Priority Data
Oct. 1, 2013 (KR) 10-2013-0117393

(51) Int. Cl. A01G 31/02; A01G 9/10; A01G 9/12; A01G 9/02

(52) U.S. Cl. CPC A01G 31/02; A01G 9/027; A01G 9/1066; A01G 9/12

(57) ABSTRACT

An environmentally-friendly aquatic plant growing holder allows aquatic plants that grow near or in water to be planted without soil or sand, enables the stem portions of aquatic plants to be supported in an upright position, and allows the roots to grow outside the body of the holder to induce natural plant growth. The plant growing holder is manufactured with various materials such as ceramic, glass, crystal, metal, etc., so that aquatic plants that grow in wetlands and most plants that grow in soil but can be planted without sand or soil may be planted in a planting tool such as a basin type small plate, bowl, cup, jar, fishbowl or manmade pond. The plant growing holder has a through-hole that cap may be adjusted, thereby allowing the aquatic plant's stem and roots to be induced to grow freely in water and allowing the plant to be firmly supported.

### TECHNICAL FIELD

The present invention relates to an environmentally-friendly aquatic plant growing holder. More particularly, it relates to an environmentally-friendly aquatic plant growing holder capable of planting aquatic plants that grow near or in water and most plants that grow in soil but may be planted in water and holding the stem part of an aquatic plant to be upright, thereby letting the roots grow out from the holder's body, to induce natural plant growth.

### BACKGROUND OF ART

In general, in wetlands, aquatic plants such as water lilies, sweet flags, water parsley, irises, duckweed, cattail, etc. grow naturally.

In order to plant such aquatic plants and most plants that grow in soil but may be planted in water for decorative use without soil and sand, a special tool and a planting tool such as a small plate, bowl, cup, pot, clear glass bowl, fishbowl or manmade pond etc. have to be used.

Conventionally, to plant and support an aquatic plant's lower stem part and roots and etc., spreading sand or soil in the planting tool is necessarily required, and the biggest reason for this is to provide nutrients from the sand or soil, but it is also for holding the aquatic plant's stem and root to fix it.

However, as sand or soil is used for holding the aquatic plant to grow it for decorative use, there is a problem of natural sentimental beauty being lost due to the sand or soil covering the aquatic plant's growth process.

Also, in a case where sand or soil is spread in a planting tool, there is an inconvenience and uncomfortableness of having to repeatedly replace contaminated sand or soil after a certain period of time.

Furthermore, in a case where the aquatic plant is planted in shallow sand or clay or etc. to be held, there is a disadvantage of the aquatic plant not growing well due to the aquatic plant's roots falling out easily with the decrease in holding and supporting strength of the aquatic plant.

In view of the above problems, the applicant of the present application has already filed a patent application for an aquatic plant growing holder made in a structure where the aquatic plant's stem and roots may grow freely out from the holder's container and can be supported so that the aquatic plant's stem and etc. doesn't float or tilt to the side and has been granted a patent (Korean patent no. 10-1293075 (registered on Jul. 30, 2013).

However, in the case of the previously granted patent, as a guiding means for stem fixing, to fix the aquatic plant's stem, wire, stem supporting hook, sponge body and etc. were used, and thus there are disadvantages of appearance not being elegant, and not being provided firm support for the aquatic plant's stem.

### DISCLOSURE OF THE INVENTION

### Technical Problem

For resolving the aforesaid problems of the prior arts, it is an object of the present invention to provide an environmentally-friendly aquatic plant growing holder having a new structure, wherein it is manufactured with various materials such as ceramic, glass, crystal, metal, etc. so that aquatic plants that grow in wetlands and most plants that grow in soil but can be planted without sand or soil may be planted in a planting tool such as a basin type small plate, bowl, cup, jar, clear glass bowl, fishbowl or manmade pond, while it is configured to have a structure having a stem fixing cap that is removably connected to the holder's body part, thereby allowing the aquatic plant's stem and roots to be induced to grow freely in water, and regardless of the aquatic plant's stem, thickness, the plant may be firmly supported to maintain an upright state without floating on water or tilting sideways.

### Technical Solution

To achieve the above object, the present invention provides an environmentally-friendly aquatic plant growing holder comprising: a holder body part, having a fastening hole perforated at an upper part thereof and a root inducing hole perforated at surrounding side parts; and a stem fixing cap, provided in a symmetrical structure having a first cap and a second cap that are separable from each other in halves and inserted and fastened into the fastening hole of the holder body part in a mutual close contact state; characterized in that a holding through-hole holding a stem of an aquatic plant is perforated vertically at each of inner surfaces of the first cap and the second cap forming the stem fixing cap.

Preferably, characterized in that the first cap and second cap forming the stem fixing cap are configured to include a mounting member mounted in the inlet part of the holder body part's fastening hole, and an inserting member that extends integrally from the bottom part of the mounting member to be inserted and arranged into the fastening hole.

More preferably, characterized in that a bottom surface of the mounting member of the stem fixing cap and an inlet surface of the fastening hole of the holder body part are configured to be formed on a tapered surface having a downward slope, respectively.

Also, characterized in that extra space is put between the inner diameter of the fastening hole of the holder body part and the outer diameter of the first cap and second cap, so that when the first and second cap is elevated or lowered along the tapered surface of the body part, the diameter size of the holding through-hole which is the planting hole of the first cap and second cap may be adjusted.

According to a first preferred embodiment of the present invention, characterized in that the holder body part is configured to have a lower plate with a predetermined area; a plurality of cylindrical members integrally formed in a line on an upper surface of the lower plate; and a fastening hole in which a stem fixing cap is fastened is perforated at an upper surface of each cylindrical member, a plurality of root inducing holes are perforated at surrounding side parts, and a plurality of binding holes for connecting a buoy or wire for electrical wiring are formed at the edge location of the lower plate.

According to a second preferred embodiment of the present invention, characterized in that the holder body part is configured to have a hollow integrated form of a rectangular block, and a lower plate of the rectangular block is a closed structure while a plurality of fastening holes in which a stem fixing cap is fastened are perforated at an upper plate, and a plurality of root inducing holes are perforated at surrounding side plates, and a plurality of binding holes for connecting a buoy or wire for electrical wiring are formed located at both sides of the fastening holes.

According to a third preferred embodiment of the present invention, the holder body part is configured to have: a lower plate with a predetermined area; and a plurality of cylindrical members arranged on the center of the upper surface of the lower plate and along a circumferential direction of the center; wherein a fastening hole in which a stem fixing cap is fastened is perforated at an upper surface of each cylindrical member, a plurality of root inducing holes are perforated at surrounding side parts, and a plurality of binding holes for connecting a buoy or wire for electrical wiring are formed at the edge location of the lower plate.

According to a fourth preferred embodiment of the present invention, the holder body part is configured to have a hollow unitary cylindrical member structure, wherein a lower plate of the unitary cylindrical member is a closed structure, and a fastening hole in which a stem fixing cap is fastened is perforated at an upper plate, and a plurality of root inducing holes are perforated at surrounding side parts.

According to the above-described first to fourth embodiments, at a location that corresponds to the fastening hole at the upper surface of each lower plate of the holder body part, a protruding support which supports the end portion of an aquatic plant's stem is further seated.

According to a fifth preferred embodiment of the present invention, the holder body part is configured to have a quadrilateral plate member form, wherein a fastening hole in which a stem fixing cap is fastened is perforated at a center part of the quadrilateral plate member, and a finger fitting unit is formed at surrounding edges, and a traction hook fitting hole is perforated at an exterior side location of the finger fitting unit so that a traction hook for raising the quadrilateral plate member to a predetermined height may fit.

According to a sixth preferred embodiment of the present invention, the holder body part is configured to have: a cylindrical body member vertically perforated with a fastening hole in which a stem fixing cap is fastened, and a plurality of wing members formed integrally and equally spaced to the outer diameter surface of the cylindrical body member, wherein a traction hook fitting hole is perforated so that a traction hook for raising the cylindrical body member and wing member to a predetermined height may fit.

According to a seventh preferred embodiment of the present invention, the holder body part is configured to have: a cylindrical body member vertically perforated with a fastening hole in which a stem fixing cap is fastened, and a plurality of wing members formed integrally and equally spaced to the outer diameter surface of the cylindrical body member, wherein the cylindrical body member and the wing member are manufactured to have the same increasing thickness.

Through the above-described technical solution, the present invention provides the following effects.

### Advantageous Effects

According to the present invention, all aquatic plants such as water lilies, sweet flags, water parsley, irises, duckweed, cattail and plants that grow in soil but may be planted in water may be planted in a basin type small plate, bowl, cup, jar, clear glass bowl, fishbowl or manmade pond, etc. without soil and sand, allowing anyone to be able to admire the aquatic plant as it is easily managed and tended.

In particular, by removably connecting a stem fixing cap that can hold a stem part of an aquatic plant to the upper surface opening of a holder's body part according to the present invention, the aquatic plant may be easily prevented from having to float in water, tilt to one side, or shake, and ultimately a firm supporting strength for the aquatic plant to stand upright may be provided.

In particular, a stem fixing cap that can hold a stem part of an aquatic plant is removably connected to the upper surface opening of a holder's body part, while extra space is put between the inner diameter of the fastening hole of the holder body part and the outer diameter of the first cap and second cap, thereby when the first and second cap is elevated or lowered along the tapered surface (inclined surface) of the body part, the diameter size of the holding through-hole which is the planting hole of the first cap and second cap may be freely adjusted, and the aquatic plant may be easily prevented from having to float in water, tilt to one side, or shake, and ultimately a firm supporting strength for the aquatic plant to stand upright may be provided.

Also, the opposing faces of body part upper surface opening of the holder and the stem fixing cap contacting each other is formed as a tapered surface like a funnel, thereby stems with different diameters may all be strongly held, and as a plant's stem grows thicker, because each cap is pushed up reversely along the tapered surface, there is an advantage of the plant not getting any growth disorders.

Further, a hook part that can bind wire or electrical wiring and the like is formed at a predetermined location of the holder's body part, thereby the upper end of wire bound with the hook part may be used with a decorative floating means (rubber ball, balloon, etc.) that floats on water, and in the case of electrical wiring, it can be used as a power providing line and the like for decorative lighting means inside the water.

### BRIEF DESCRIPTION OF THE DRAWINGS

FIG. 1 is a perspective view of a stem fixing cap used in an environmentally-friendly aquatic plant growing holder according to the present invention,

FIGS. 2-4 are drawings showing a holder body part of an environmentally-friendly aquatic plant growing holder according to a first preferred embodiment of the present invention, and a state of an aquatic plant's stem being fixed using a stem fixing cap,

FIGS. 5-9 are drawings showing a holder body part of an environmentally-friendly aquatic plant growing holder according to a second preferred embodiment of the present invention, and a state of an aquatic plant's stem being fixed using a stem fixing cap,

FIG. 10 is a drawing showing a holder body part of an environmentally-friendly aquatic plant growing holder according to a third preferred embodiment of the present invention,

FIGS. 11-13 are drawings showing a holder body part of an environmentally-friendly aquatic plant growing holder according to a fourth preferred embodiment of the present invention, and a state of an aquatic plant's stem being fixed using a stem fixing cap,

FIGS. 14-16 are drawings showing a holder body part of an environmentally-friendly aquatic plant growing holder according to a fifth preferred embodiment of the present invention, and a state of an aquatic plant's stem being fixed using a stem fixing cap,

FIGS. 17 and 18 are drawings showing a holder body part of an environmentally-friendly aquatic plant growing holder according to a sixth preferred embodiment of the present invention, and a state of an aquatic plant's stem being fixed using a stem fixing cap.

FIGS. 19 and 20 are drawings showing a holder body part of an environmentally-friendly aquatic plant growing holder according to a seventh preferred embodiment of the present invention, and a state of an aquatic plant's stem being fixed using a stem fixing cap.

### DETAILED DESCRIPTION OF THE EMBODIMENTS

Hereinafter, the present invention will be described in more detail with reference to the following embodiments.

The present invention focuses on a point in which, without using sand or soil, disposed in various planting tools (small plate, bowl, cup, jar, clear glass bowl, fishbowl or manmade pond, etc.), an aquatic plant's roots and stem may be held so it is shown outside, and so that in particular, the aquatic plant's stem and roots are sure to be induced to grow freely in water, and regardless of the aquatic plant's stem thickness, the plant may be firmly supported to maintain an upright state without floating on water or tilting sideways.

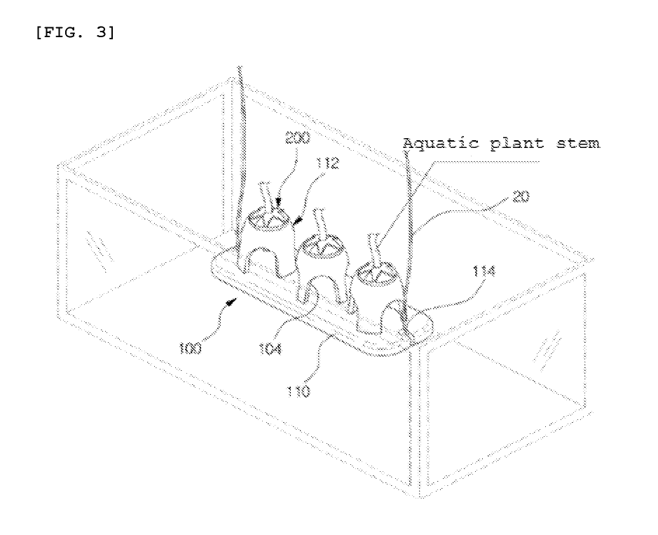

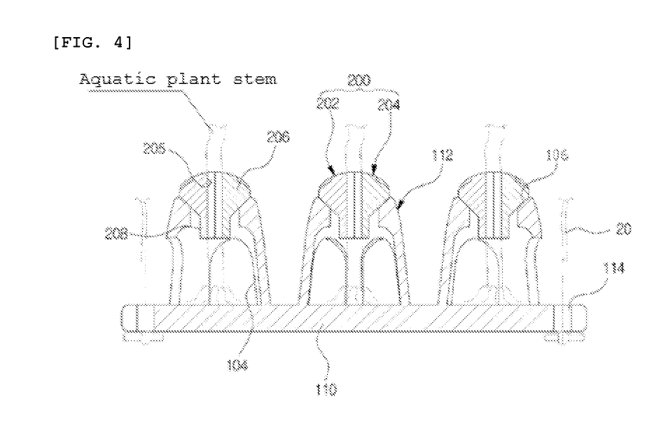

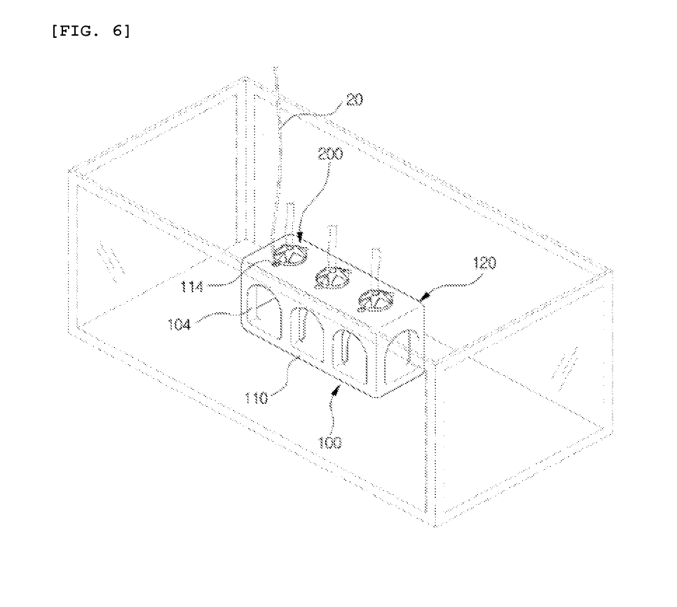

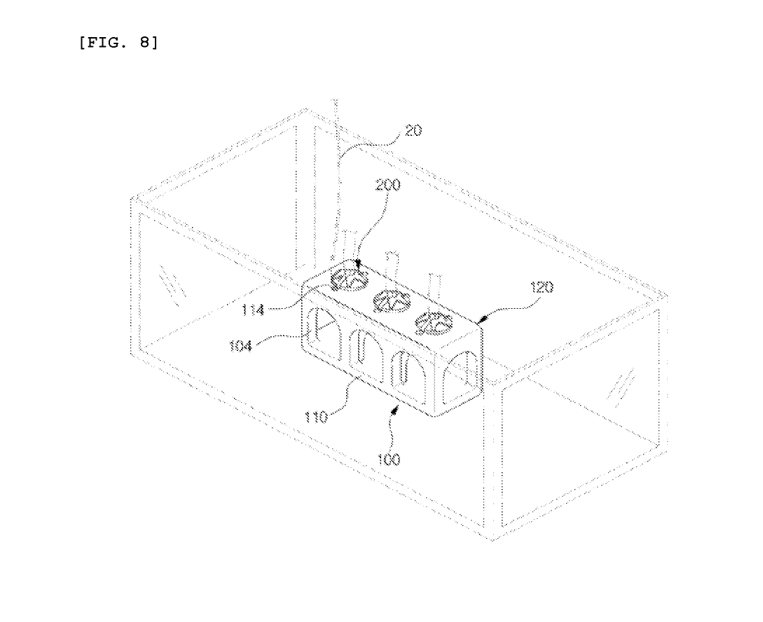

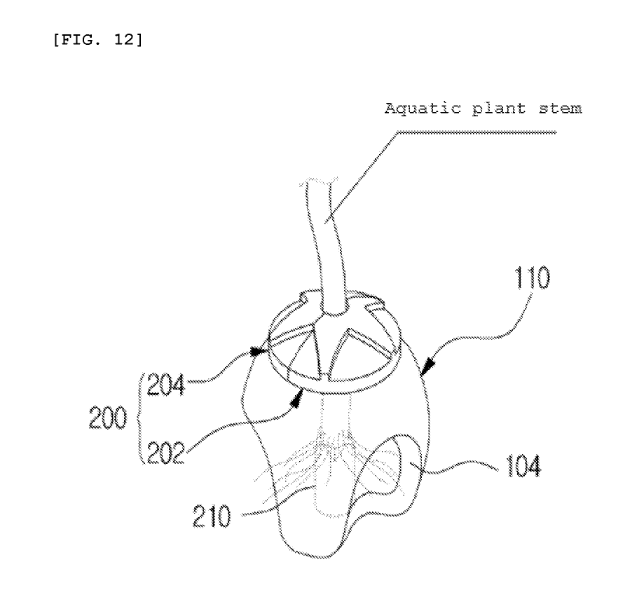

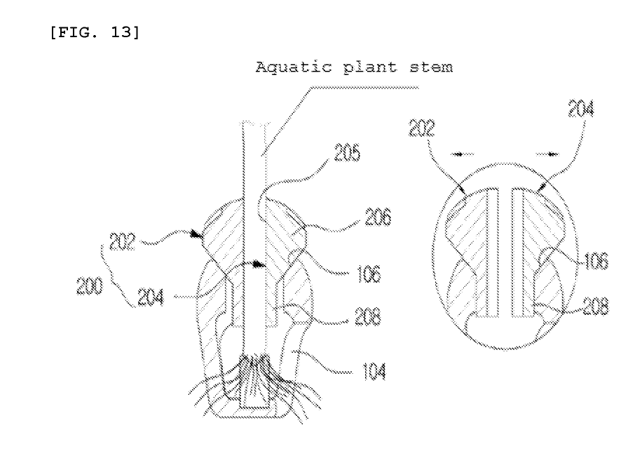

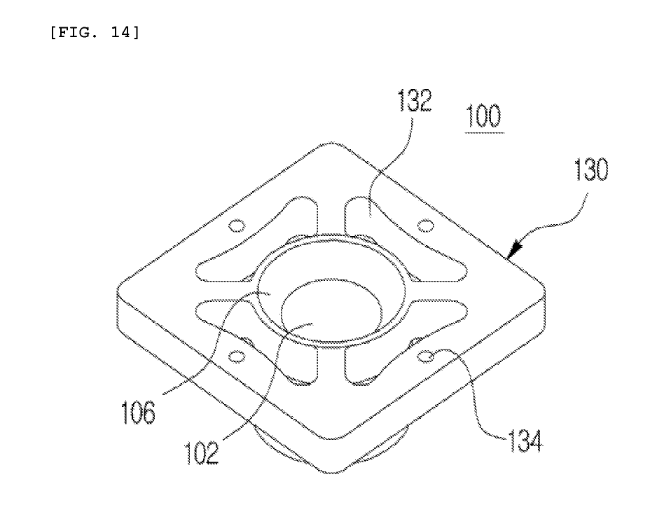

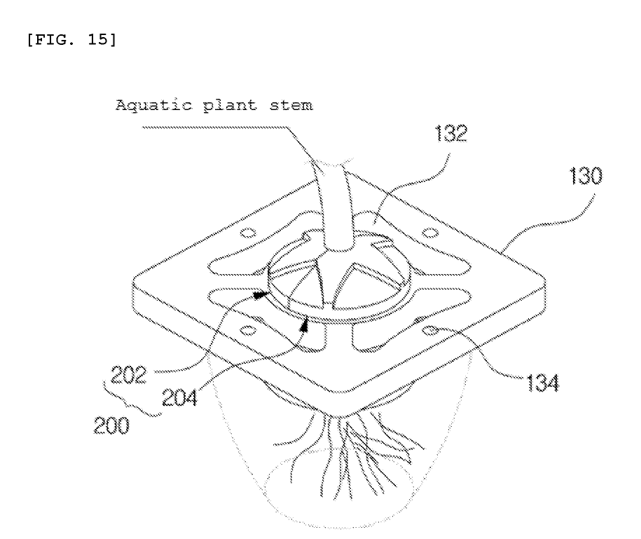

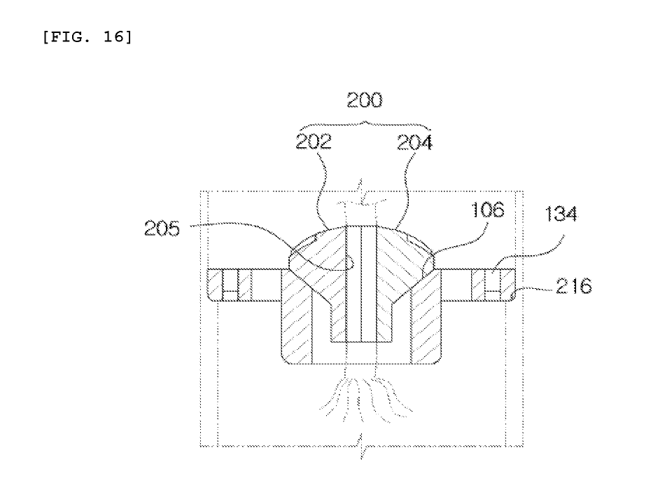

For this, according to the present invention an aquatic plant growing holder is formed using various materials such as ceramic, glass, crystal, metal, etc. wherein as shown in each embodiment illustrated in FIGS. 2-20, it is configured to comprise a holder body part 100, having a fastening hole 102 perforated as well as a root inducing hole 104 perforated at surrounding side parts, and a stem fixing cap 200, provided in a symmetrical structure having a first cap 202 and a second cap 204 that separable from each other in halves, and inserted and fastened into the fastening hole 102 of the holder body part 100.

The holder body part 100 may be manufactured in various forms and shapes according to design, and depending on its use, whether it is to be placed in a manmade pond, cup, or basin, it may be manufactured in various sizes, and each embodiment according to its design and use will be described below.

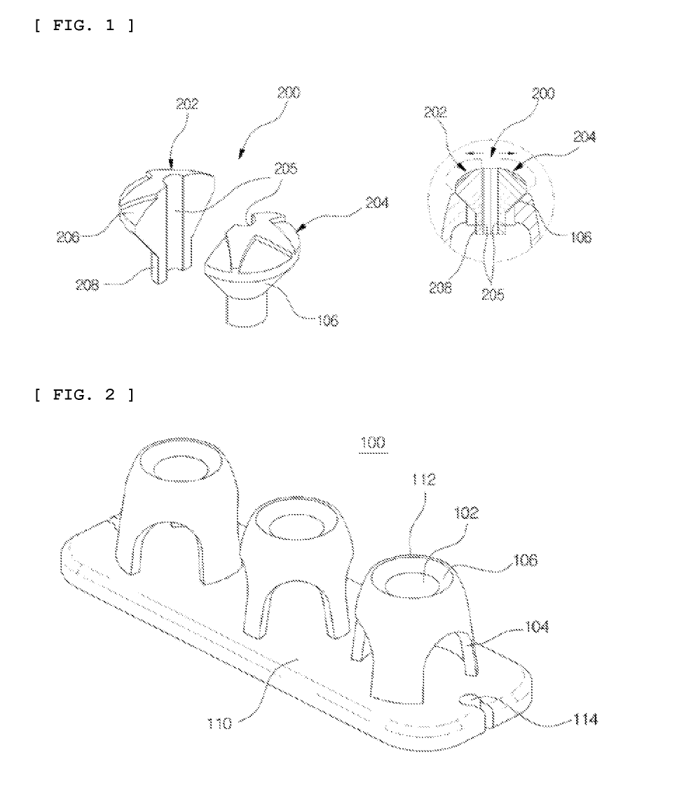

In particular, the stem fixing cap 200, as shown well in the accompanying FIG. 1, is configured with a first cap 202 and a second cap 204 that are separate halves in a symmetrical structure, and at the inner surface of each of the first cap 202 and the second cap 204, a holding through-hole 205 having a semicircular cross-section for holding an aquatic plant's stem is perforated vertically.

More specifically, the first cap 202 and second cap 204 forming the stem fixing cap 200 each form a separate half while having a mutual symmetrical structure, wherein they can be divided into a mounting member 206 formed to have a bigger diameter than that of the fastening hole 102 of the holder body part 100 to be mounted near the inlet part of the fastening hole 102, and an inserting member 208 that extends integrally from the bottom part of the mounting member 206 to be directly inserted and arranged into the fastening hole 102.

Of course, on the inner surface of both the mounting member 206 and inserting member 208 forming the first cap 202 and second cap 204 a vertically perforated holding through-hole 205 with a semicircular cross-section is formed.

In this case, the reason for forming a long inserting member 208 extended from the bottom part of the mounting member 206 as well as the mounting member 206 of the first and second cap which configures the stem fixing cap 200 is to lessen the angle of a plant's tilt by ensuring that the stem of the plant is stably supported in close contact over the holding through-hole 205 of the mounting member 206 and inserting member 20.

Therefore, the first cap 202 and second cap 204 are in close contact with each other while at the holding through-hole 205 of each cap the stem of the aquatic plant passes through, and with this the first cap 202 and second cap 204 are inserted and fastened into the fastening hole 102 of the holder body part 100 in a mutual close contact state, thereby the mounting member 206 of each cap is mounted at the exterior circumferential surface of the inlet of the fastening hole 102 while the inserting member 208 is in a state inserted in the fastening hole 102.

Accordingly, since the stem part of the aquatic plant is in a close contact state with the inner circumferential surface of the holding through-hole 205 of the first cap 202 and second cap 204, the stem part of the aquatic plant is in a state in which it maintains its uprightness and is made to stand easily.

That is, by having the exterior circumference part of the aquatic plant's stem be in close contact with the inner circumferential surface of the holding through-hole 205 of the first cap 202 and second cap 204 which configures the stem fixing cap 200, a sturdy upright state is maintained and the lower end of the aquatic plant's stem is arranged extended to the floor surface of the holder body part 100.

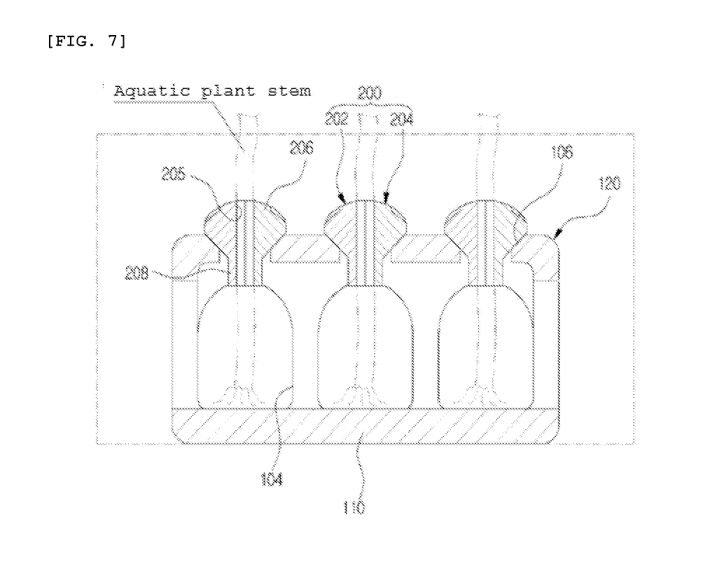

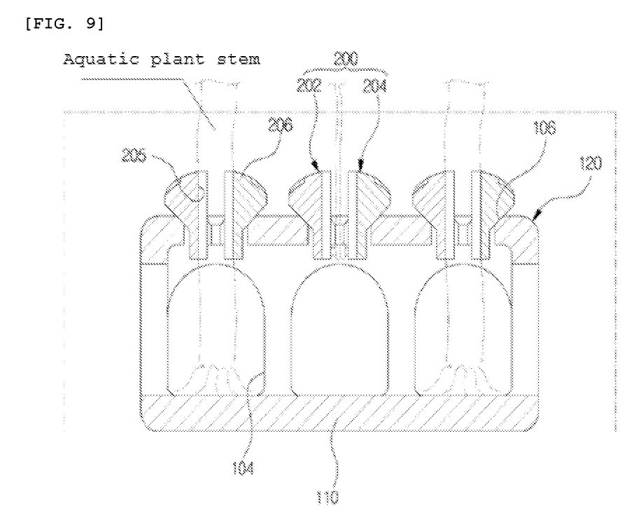

On the other hand, as shown well in the accompanying FIGS. 7 and 9, bottom surface of mounting member 206 of the stem fixing cap 200 and the inlet surface of the fastening hole 102 of the holder body part 100 are formed on tapered surface 106 having a downward slope, respectively. The reason for this is because the diameters of various aquatic plant stems are different from each other, and it is in order to ensure firm close contact support for stems of different diameters.

More preferably, as shown enlarged view of accompanying FIG. 1, the inner diameter of the fastening hole 102 of the holder body part 100 and the outer diameter of the first cap 202 and second cap 204 are made to have an extra space therebetween. The reason for this is because the diameter of various aquatic plant stems are different from each other, and so that as each can is elevated or lowered along the tapered surface of the body part, firm close contact support for stems of different diameters may be ensured.

More specifically, by having the outer circumferential surface of the inlet of the fastening hole of the holder body part and the bottom surface of the mounting member 206 or stem fixing cap formed with a downwardly inclined tapered surface 106 such as a funnel, as shown in FIGS. 7 and 9, even if the first cap 202 and second cap 204 forming the stem fixing cap 200 are in a close contact state with stems of different diameters, each of the tapered surface formed at the bottom surface of the mounting member 206 of each cap comes to a mounted state as it is slid in a downwardly direction along the tapered surface formed at the exterior circumferential inlet of the fastening hole 102, therefore enabling a sturdy hold on different sized stems, and as a plant's stem grows thicker or bigger, because it grows as each cap is pushed up reversely along the tapered surface, the plant doesn't get any growth disorders.

Thus, all aquatic plants such as water lilies, sweet flags, water parsley, irises, duckweed, cattail and plants that grow in soil but may be planted in water may be planted without sand or soil, while stem fixing cap is used to hold a stem part of an aquatic plant, supporting it so it doesn't tilt to one side or shake and enabling it to grow.

Herein, each embodiment of a holder body part of the present invention, and the process of planting an aquatic plant in an upright state using a stem fixing cap on the holder body part in accordance with each embodiment will be described as follows.

### The First Embodiment

According to a first preferred embodiment of the holder body part 100, as shown in accompanying FIGS. 2-4, it is configured to have a lower plate 110 with a predetermined area and a plurality of cylindrical members 112 integrally formed in a line on an upper surface of the lower plate 110, to be used for being placed on the floor surface inside water of a manmade pond.

Particularly, a fastening hole 102 in which a stem fixing cap 200 is fastened is perforated at an upper surface of each cylindrical member 112, and a plurality of root inducing holes 104 are perforated at surrounding side parts.

Of course, the exterior circumferential surface of the inlet of the fastening hole 102 formed at each of the cylindrical members 112, and the bottom surface of the mounting member 206 of the stem fixing cap 200 are formed as downwardly inclined tapered surfaces 106.

Also, an extra space exists between the inner diameter of the fastening hole 102 of the holder body part 100 and the outer diameter of the first cap 202 and second cap 204.

Therefore, the first cap 202 and second cap 204 forming the stem fixing cap 200 are made to be in close contact with each other while at the holding through-hole 205 of each cap the stem of the aquatic plant passes through, and with this the first cap 202 and second cap 204 are inserted and fastened into the fastening hole 102 of the holder body part 100 in a mutual close contact state, thereby the mounting member 206 of each cap is mounted at the exterior circumferential surface of the inlet of the fastening hole 102 while the inserting member 208 is in a state inserted in the fastening hole 102.

Accordingly, since the stem part of the aquatic plant is in a close contact state with the inner diameter surface of the holding through-hole 205 of the first cap 202 and second cap 204, and in particular, an extra space is put between the inner diameter of the fastening hole 102 of the holder body part 100 and the outer diameter of the first cap 202 and second cap 204, so that when each cap is elevated or lowered along the tapered surface of the body part 100, the diameter size of the holding through-hole 205 which is the planting hole of the first cap 202 and second cap 204 may be adjusted, thereby the stem part of the aquatic plant is in a state in which it maintains its uprightness and is made to stand easily, and the root part of the aquatic plant passes through the root inducing hole 104 into an arranged state as it grows.

On the other hand, a plurality of binding holes 114 for connecting a buoy (for example, rubber balloon, tube, etc.) or wire 212 for electrical wiring are further formed at an edge location of the lower plate member 110.

Thus, by binding a wire 212 connected to a buoy to a binding hole 114, the buoy may not depart from its position on the surface of the water, and a plurality of buoys may be suspended so when seen from above the water, each buoy make a part of a certain form (for example, a heart, etc.) of pattern as it stays afloat on the water, therefore the holder body part 100 according to the first embodiment may be used for exterior decorative application by a buoy as well as for planting aquatic plants inside a manmade pond.

Also, when decorating lights inside the manmade pond, the binding hole 114 may be used for binding electrical wires as needed.

### The Second Embodiment

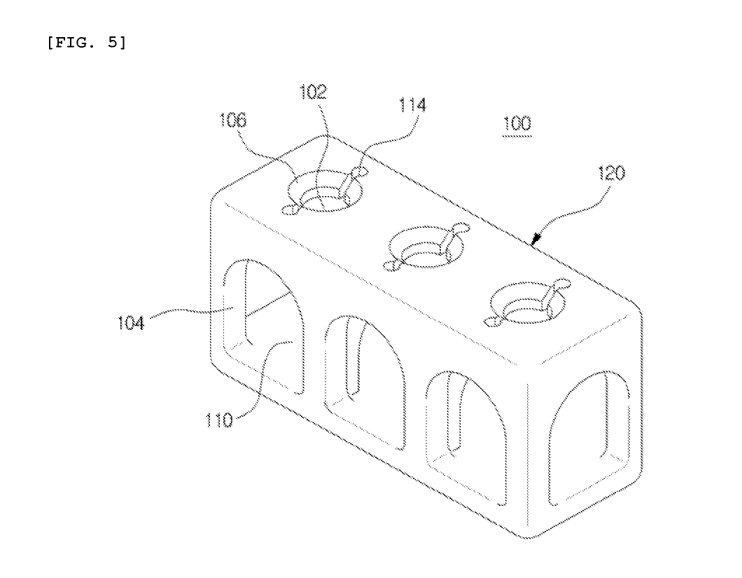

According to a second embodiment as shown in accompanying FIGS. 5-9, a holder body part 100 is configured to have a hollow integrated form of a rectangular block 120, to be used for being placed on the floor surface inside water of a manmade pond.

A lower plate 110 of the rectangular block 120 is a closed structure to protect a plant's roots in case the holder is lifted and put down, and a plurality of fastening holes 102 in which a stem fixing cap 200 is fastened are perforated equally spaced in a line at an upper plate, and a plurality of root inducing holes 104 are perforated at surrounding side plates.

Therefore, the first cap 202 and second cap 204 that configure the stem fixing cap 200 are made to be in close contact with each other while at the holding through-hole 205 of each cap, the stem of the aquatic plant passes through, and with this the first cap 202 and second cap 204 are inserted and fastened into the fastening hole 102 of the rectangular block 120 in a mutual close contact state, thereby the mounting member 206 of each cap is mounted at the exterior circumferential surface of the inlet of the fastening hole 102 while the inserting member 208 is in a state inserted in the fastening hole 102.

Similarly, the inner diameter surface of the first cap 202 and second cap 204 of the holding through-hole 205 are made to be in a close contact state with a stem part of an aquatic plant, thereby the stem part of the aquatic plant is made into a state in which it maintains its uprightness and is made to stand easily, and the root part of the aquatic plant passes through the root inducing hole 104 into an arranged state as it grows.

In this case, a plurality of binding holes 114 for connecting a buoy (for example, rubber balloon, tube, etc.) or wire 212 for electrical wiring are further formed at an exterior circumferential part of each fastening hole 102 of the rectangular block 120, to be utilized as a buoy decoration and electric wiring use.

### The Third Embodiment

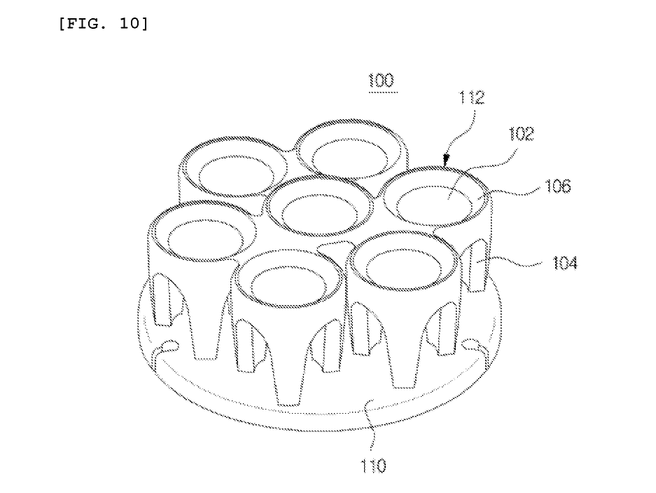

According to a third embodiment as shown in accompanying FIG. 10, a holder body part 100 is configured to have a circular lower plate 110 with a predetermined area, and a plurality of cylindrical members 112 arranged on the center of the upper surface of the lower plate 110 and along a circumferential direction of the center, to be used for being placed on the floor surface inside water of a big basin or manmade pond filled with water.

A plurality of fastening holes 102 in which a stem fixing cap 200 is fastened are perforated at an upper surface of each cylindrical member 112 formed above the lower plate 110, and a plurality of root inducing holes 104 are perforated at surrounding side parts.

Therefore, by inserting and fastening the first cap 202 and second cap 204 that configure the stem fixing cap 200 into the fastening hole 102, the mounting member 206 of each cap is mounted at the exterior circumferential surface of the inlet of the fastening hole 102 while the inserting member 208 is in a state inserted in the fastening hole 102.

Similarly, the inner diameter surface of the first cap 202 and second cap 204 of the holding through-hole 205 are made to be in a close contact state with a stem part of an aquatic plant, thereby the stem part of the aquatic plant is made into a state in which it maintains its uprightness and is made to stand easily, and the root part of the aquatic plant passes through the root inducing hole 104 into an arranged state as it grows.

In this case, a plurality of binding holes 114 for connecting a buoy or wire for electrical wiring are further formed at the edge location of the circular lower plate 110, to be utilized as a buoy decoration and electric wiring use.

### The Fourth Embodiment

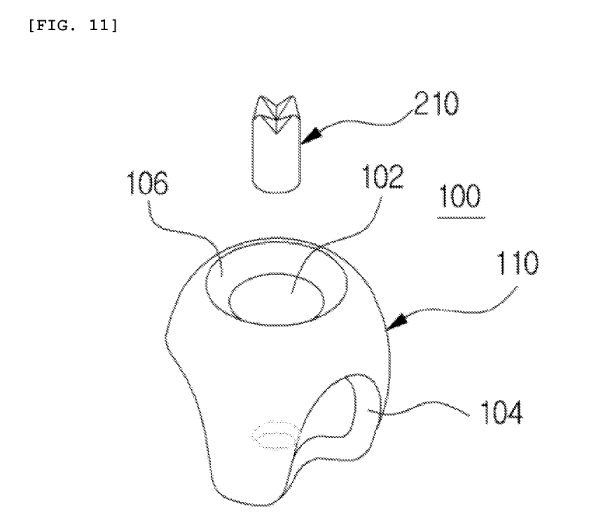

According to a fourth embodiment as shown in accompanying FIGS. 11-13, a holder body part 100 is configured to have a hollow unitary cylindrical member structure, to be used for not only being placed in a manmade pond, but also for a basin able to be placed indoors and etc.

Of course, A lower plate 110 of the unitary cylindrical member 112 is a closed structure to protect a plant's roots in case the holder is lifted and put down, and a fastening hole 102 in which a stem fixing cap 200 is fastened is perforated at an upper surface, and a root inducing hole 104 is perforated at surrounding side parts.

Similarly, when the stem fixing cap 200 is inserted and fastened in the fastening hole 102 of the unitary cylindrical member 112, the stem part of the aquatic plant is made to be in a close contact state with the inner diameter surface of the holding through-hole 205 of the first cap 202 and second cap 204, and in particular, an extra space is put between the inner diameter of the fastening hole 102 of the holder body part 100 and the outer diameter of the first cap 202 and second cap 204, so that when each cap is elevated or lowered along the tapered surface of the body part 100, the diameter size of the holding through-hole 205 which is the planting hole of the first cap 202 and second cap 204 may be adjusted, thereby the stem part of the aquatic plant is made into a state in which it maintains its uprightness and is made to stand easily, and the root part of the aquatic plant passes through the root inducing hole 104 into an arranged state as it grows.

On the other hand, according to the above-described first to fourth embodiments, as shown in accompanying FIG. 11-13, at the upper surface of each lower plate 110 of each holder body part 100, there may be further seated a protruding support 210 which fixes the end portion of an aquatic plant's stem one more time so it doesn't tilt.

Therefore, with the end portion of the aquatic plant's stem that maintains its upright state by the stem fixing cap 200 in a state extended to the upper surface of each lower plate 110 of each holder body part 100 according to the first to fourth embodiments, by having the root part that grew out from the end portion of the stem be mounted and supported at a protrusion part formed on the upper surface of the protruding support 210, the stem of the aquatic plant maintains the desired upright state as it is provided stronger supporting strength.

### The Fifth Embodiment

According to a fifth embodiment as shown in accompanying FIGS. 14-16, a holder body part 100 is configured to have a quadrilateral plate member form, to be used for being placed in a quadrilateral water tank or may be mounted inside a quadrilateral shaped cup.

For example, as illustrated in FIG. 16, the holder body part 100 is configured to have a quadrilateral plate member 130, and the corners of the quadrilateral plate member 130 may be mounted on a stepped portion 216 formed on an inner diameter surface of a big quadrilateral basin.

A fastening hole 102 in which a stem fixing cap 200 is fastened is perforated at a center part of the quadrilateral plate member 130, and a finger fitting unit 132 is formed at surrounding edges for handling purposes, to insert the quadrilateral plate member 130 inside a cup.

Therefore, after putting fingers in the finger fitting unit 132 of the quadrilateral plate member 130, the quadrilateral plate member 130 may be put inside or mounted in a cup or water tank filled with water with a quadrilateral cross section, and if a stem fixing cap 200 is inserted fastened inside a fastening hole 102 of a quadrilateral plate member 130 subsequently, the stem part of the aquatic plant is made to be in a close contact state with the inner diameter surface of the holding through-hole 205 of the first cap 202 and second cap 204, and in particular, an extra space is put between the inner diameter of the fastening hole 102 of the holder body part 100 and the outer diameter of the first cap 202 and second cap 204, so that when each cap is elevated or lowered along the tapered surface of the body part 100, the diameter size of the holding through-hole 205 which is the planting hole of the first cap 202 and second cap 204 may be adjusted freely, thereby the stem part of the aquatic plant is made into a state in which it maintains its uprightness and is made to stand easily.

On the other hand, a traction hook fitting hole 134 is perforated at an exterior side location of the finger fitting unit 132 so that a traction hook for raising the quadrilateral plate member 130 to a predetermined height may be fit.

For example, in case the quadrilateral plate member 130 is placed inside a wide basin, the upper end of the traction hook is fit in the traction hook fitting hole 134, and the lower end is supported on the floor surface of the basin, thereby enabling the quadrilateral plate member 130 to be tugged to a predetermined height and placed.

Also, even if a traction hook is not provided, the quadrilateral plate member 130 may be mounted to be fixed on a stepped portion 216 inside a cup, and of course, a stem part of an aquatic plant is made to be in a supported state that enables uprightness by the stem fixing cap 200 inserted in the fastening hole 102 of the quadrilateral plate member 130.

### The Sixth Embodiment

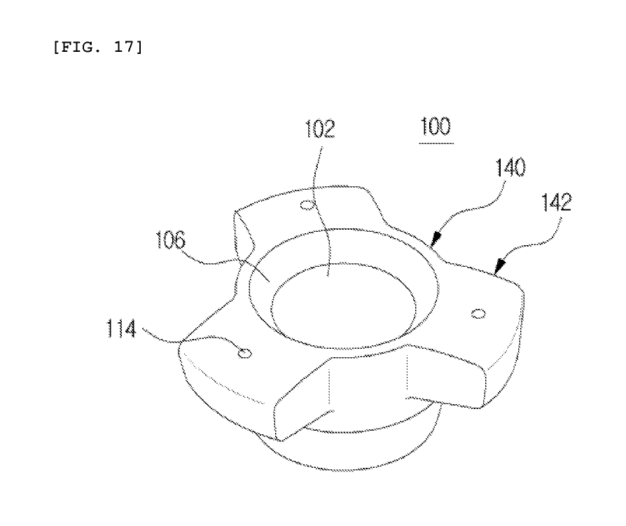

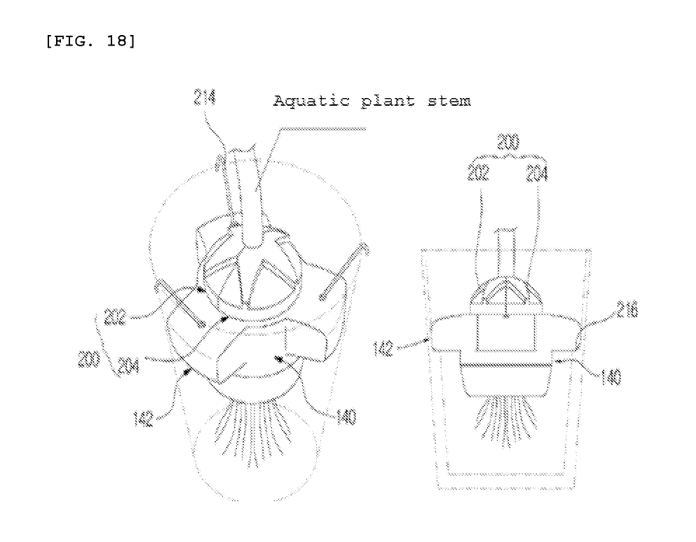

According to a sixth embodiment as shown in accompanying FIGS. 17 and 18, a holder body part 100 is configured to include a cylindrical body member 140 vertically perforated with a fastening hole 102 in which a stem fixing cap 200 is fastened, and a plurality of wing members 142 having a thinner thickness compared to the cylindrical body member 140, formed integrally and equally spaced to the outer diameter surface of the cylindrical body member 140, to be used for being mounted inside a water tank with a circular shaped cross-section or a cup with a circular shaped cross-section.

The reason for having the wing members 142 be formed with a thinner thickness compared to the cylindrical body member 140 is to enable easy mounting on a stepped portion (middle stepped portion) of an inner diameter surface of a glass cup and etc.

Therefore, after grabbing the outer diameter surface of the cylindrical body member 140 between the wing members 142, as the cylindrical body member 140 is put inside a cup or water tank with a circular shaped cross-section filled with water, the outer diameter part of wing members 142 are made to be in a mounted state in close contact with the inner diameter surface of the cup or water tank with a circular shaped cross-section.

Thus, if a stem fixing cap 200 is inserted fastened inside the fastening hole 102 of the cylindrical body member 140, the stem part of the aquatic plant is made to be in a close contact state with the inner diameter surface of the holding through-hole 205 of the first cap 202 and second cap 204, thereby the stem part of the aquatic plant is made into a state in which it maintains its uprightness and is made to stand easily.

On the other hand, a traction hook fitting hole 134 is also perforated at the wing member 142 so that a traction hook 214 for raising the cylindrical body member 140 and wing member 142 to a predetermined height may be fit.

The upper end of the traction hook 214 is fit in the traction hook fitting hole 134 of the wing member 142, and the lower end of the traction hook 214 is made to be supported on the floor surface of a planting tool (for example, a wide basin), thereby enabling the cylindrical body member 140 and wing member 142 to be tugged to a predetermined height and placed, and of course, a stem part of an aquatic plant is made to be in a supported state that enables uprightness by the stem fixing cap 200 inserted in the fastening hole 102 of the cylindrical body member 140.

Also, as illustrated in the left drawing of FIG. 18, by fitting the lower end of the traction hook 214 in the traction hook fitting hole 134 of the wing member, and mounting the upper end of the traction hook 214 on the opening of a planting tool (for example, a cup, etc.), the cylindrical body member 140 and wing member 142 inside a cup may be tugged to a predetermined height and placed, and as shown in the right drawing of FIG. 18, in the case a stepped portion 216 is formed on the inner diameter surface of a cup, the wing member 142 may be mounted as its bottom part is caught.

### The Seventh Embodiment

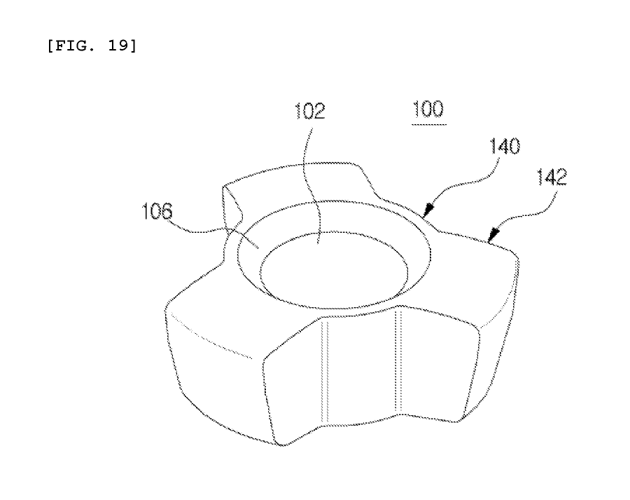

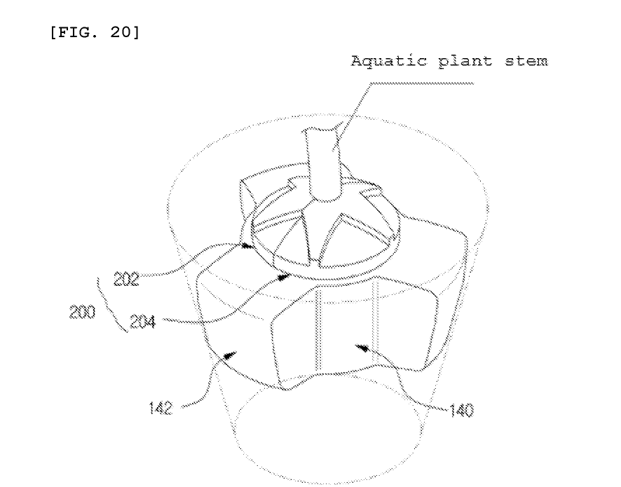

According to a seventh embodiment as shown in accompanying FIGS. 19 and 20, a holder body part 100 is configured with a cylindrical body member 140 vertically perforated with a fastening hole 102 in which a stem fixing cap 200 is fastened, and a plurality of wing members 142 formed integrally and equally spaced to the outer diameter surface of the cylindrical body member 140, and unlike the above mentioned sixth embodiment, the cylindrical body member 140 and the wing member 142 are configured to have the same thickness, to be used for being mounted inside a water tank with a circular shaped cross-section or a cup with a circular shaped cross-section.

The reason for having the wing member 142 formed with the same thickness as the cylindrical body member 140 is so that the wing member 142 may be stably mounted without any tilting at the inner diameter part of a general glass cup even if there is no stepped portion (middle stepped portion) at the inner diameter surface of a glass cup and the like.

Thus, as the holder body part 100 according to the seventh embodiment configures the thickness of the cylindrical body member 140 and wing member 142 to be thick, even if there is no stepped portion inside a general container such as a cup and the like, and even if a traction hook is not used, it can be easily inserted mounted inside the container.

Such holder body part according to each embodiment as mentioned above is placed in a manmade pond or various basin, cup, and the like, and a stem fixing cap is used to support a stem part of an aquatic plant so it doesn't tilt to one side or shake.

On the other hand, the mounting member 206 of the stem fixing cap 200 may be coated with an air freshening material with a function of treating respiratory diseases and the like, thus an effect for relieving fatigue, improving health and the like may be obtained.

In the air freshening material, a functional oil may be mixed, and the mixture ratio may be 90˜94 wt % of air freshener with 6˜10 wt % of functional oil, and this functional oil is comprised of 50 wt % of Heliotropium arborescense oil and 50 wt % of St. John's Wort oil.

In this case, it is preferable to have 6˜10 wt % of functional oil to be mixed in respect of air freshener. If the mixture ratio of functional oil is less than 6 wt %, the effect is not significant, and if the mixture ratio of the functional oil exceeds 10 wt %, the effect is not significantly improved whereas the cost for manufacturing is greatly increased.

Out of functional oils, Heliotropium arborescense oil is an aromatic plant of South America origin with the fragrance coming from dark purple or white colored flowers, wherein the oil is obtained from the flower and has a good effect on painkilling, anti-depression, and treating high blood pressure caused by mental stress and the like.

The oil extracted from St. John's Wort oil is red colored, and is very effective on anti-depression, neuralgia, muscle pain, lessening pain and treating such diseases and anti-inflammatory effect and etc.

Such functional oil coated around the circumference of the mounting member 206 of the stem fixing cap 200 may relieve fatigue and promote health and etc. of the resident living in a room with the aquatic plant growing holder.

1. An environmentally-friendly aquatic plant growing holder, wherein the holder comprises:
a holder body part having a fastening hole perforated at an upper part thereof and a root inducing hole perforated at surrounding side parts; and
a stem fixing cap provided as a symmetrical structure having a first cap and a second cap that are separable from each other in halves and inserted and fastened into the fastening hole of the holder body part in a mutual close contact state, wherein,
a holding through-hole holding a stem of the aquatic plant is perforated vertically at each of inner surfaces of the first cap and the second cap forming the stem fixing cap.

2. The environmentally-friendly aquatic plant growing holder according to claim 1, wherein:
the first cap and the second cap forming the stem fixing cap are configured to include a mounting member mounted in an inlet part of the fastening hole of the holder body part, and an inserting member that integrally extends from a bottom part of the mounting member to be inserted and arranged into the fastening hole.

3. The environmentally-friendly aquatic plant growing holder according to claim 2, wherein:
a bottom surface of the mounting member of the stem fixing cap and an inlet surface of the fastening hole of the holder body part are configured to be formed on a tapered surface having a downward slope, respectively, and to have an extra space between an inner diameter of the fastening hole of the holder body part and an outer diameter of the first cap and second cap.

4. The environmentally-friendly aquatic plant growing holder according to claim 1, wherein:
the holder body part is configured to have a lower plate with a predetermined area and a plurality of cylindrical members integrally formed in a line on an upper surface of the lower plate,
a fastening hole in which a stem fixing cap is fastened is perforated at an upper surface of each cylindrical member,
a plurality of root inducing holes are perforated at surrounding side parts, and
a plurality of binding holes connecting a buoy or wire for electrical wiring are formed at an edge location of the lower plate.

5. The environmentally-friendly aquatic plant growing holder according to claim 1, wherein:
the holder body part is configured to have a hollow integrated form of a rectangular block, wherein:
a lower plate of the rectangular block is a closed structure while a plurality of fastening holes in which a stem fixing cap is fastened are perforated at an upper plate,
a plurality of root inducing holes are perforated at surrounding side plates, and
a plurality of binding holes connecting a buoy or wire for electrical wiring are formed on locations of both sides of the fastening holes.

6. The environmentally-friendly aquatic plant growing holder according to claim 1, wherein:
the holder body part is configured to include a lower plate with a predetermined area and a plurality of cylindrical members arranged on a center of an upper surface of the lower plate and along a circumferential direction of the center, wherein:
the fastening hole in which the stem fixing cap is fastened is perforated at an upper surface of each cylindrical member,
a plurality of root inducing holes are perforated at surrounding side parts, and
a plurality of binding holes connecting a buoy or wire for electrical wiring are formed at an edge location of the lower plate.

7. The environmentally-friendly aquatic plant growing holder according to claim 1, wherein:
the holder body part is configured to have a hollow unitary cylindrical member structure, wherein:
a lower plate of the unitary cylindrical member is a closed structure,
the fastening hole in which the stem fixing cap is fastened is perforated at an upper plate, and
a plurality of root inducing holes are perforated at surrounding side parts.

8. The environmentally-friendly aquatic plant growing holder according to claim 4, wherein:
a protruding support which supports the end portion of an aquatic plant's stem is further seated on a location that corresponds to the fastening hole at the upper surface of each lower plate of the holder body part.

9. The environmentally-friendly aquatic plant growing holder according to claim 1, wherein:
the holder body part is configured to have a quadrilateral plate member form, wherein:
the fastening hole in which the stem fixing cap is fastened is perforated at a center part of the quadrilateral plate member,
a finger fitting unit is formed at surrounding edges, and
a traction hook fitting hole is perforated at an exterior side location of the finger fitting unit so that a traction hook for raising the quadrilateral plate member to a predetermined height may be fit.

10. The environmentally-friendly aquatic plant growing holder according to claim 1, wherein:
the holder body part is configured to have a cylindrical body member vertically perforated with a fastening hole in which a stem fixing cap is fastened and a plurality of wing members formed integrally and equally spaced to an outer diameter surface of the cylindrical body member, wherein:
a traction hook fitting hole is perforated at each wing member so that a traction hook for raising the cylindrical body member and wing member to a predetermined height may be fit.

11. The environmentally-friendly aquatic plant growing holder according to claim 5, wherein:
a protruding support which supports the end portion of an aquatic plant's stem is further seated on a location that corresponds to the fastening hole at the upper surface of each lower plate of the holder body part.

12. The environmentally-friendly aquatic plant growing holder according to claim 6, wherein:
a protruding support which supports the end portion of an aquatic plant's stem is further seated on a location that corresponds to the fastening hole at the upper surface of each lower plate of the holder body part.

13. The environmentally-friendly aquatic plant growing holder according to claim 7, wherein:
a protruding support which supports the end portion of an aquatic plant's stem is further seated on a location that corresponds to the fastening hole at the upper surface of each lower plate of the holder body part.
